(19) United States
(12) Patent Application Publication
(10) Pub. No.: US 2023/0371737 A1
(43) Pub. Date: Nov. 23, 2023

(54) A Cooking Appliance Comprising A Heating Assembly In The Lid

(71) Applicant: ZHEJIANG SUPOR ELECTRICAL APPLIANCES MANUFACTURING CO., LTD., Hangzhou, Zhejiang (CN)

(72) Inventors: Jie Yang, Hangzhou, Zhejiang (CN); Yiqiong Liu, Hangzhou, Zhejiang (CN); Xiang Liu, Hangzhou, Zhejiang (CN)

(73) Assignee: ZHEJIANG SUPOR ELECTRICAL APPLIANCES MANUFACTURING CO., LTD., Hangzhou, Zhejiang (CN)

(21) Appl. No.: 18/031,445

(22) PCT Filed: Oct. 23, 2020
(86) PCT No.: PCT/CN2020/123286

§ 371 Date: Apr. 12, 2023

(51) Int. Cl. A47J 36/06; A47J 27/00; H05B 3/44

(52) U.S. Cl. CPC A47J 36/06; A47J 27/004; H05B 3/44

(57) ABSTRACT

A cooking appliance includes a lid and an inner pot forming a cooking space for receiving food material. The lid is arranged over the inner pot and movable between a closed position and an open position and includes a heating assembly including a heating device, a reflective plate and a light-transmission plate located below the reflective plate. The reflective plate and the light-transmission plate define a heating space in which the heating device is arranged. The heating device includes a first heating tube and a second heating tube, each having a semi-enclosed shape with an opening. The first heating tube is surrounded by the second heating tube and the opening of the first heating tube is arranged to face a body portion of the second heating tube without opening. The reflective plate includes a reflection enhancing zone disposed between the first and second heating tubes, the reflection enhancing zone is configured to enhance the reflection of radiation for both the first and second heating tubes.

### FIELD OF THE INVENTION

The invention relates to the technical field of cooking appliance, and in particular to a multicooker with baking or grill functions.

### BACKGROUND OF THE INVENTION

To meet the people's diverse cooking needs and to save space in the kitchen, multicookers are one of the rapidly developing electrical appliances. They are widely used for cooking various food materials, such as rice, beans, and even cakes. The multicooker generally comprises an inner pot forming a cooking space for receiving food material and a lid being arranged over the inner pot and movable between a closed position and an open position. When the multicooker is designed to provide baking or grill functions, the lid may comprise a top heating assembly, in addition to the heating plate usually provided at the bottom of the cooking space, so as to heat the food material from the top as well.

Existing top heating assemblies often comprise a single heating tube, such as a far-infrared heating tube. The heating tube is a tubular electric heating element that converts electrical energy to heat based on Joule effect. Typically, a heating tube comprises a metallic filament enclosed in a shell. When powered by electricity, the metallic filament generates a radiation of certain wavelengths. Such heating tubes are known in prior art and widely used as heating device in electrical cookers. However, due to the arrangement of the metallic filament in the heating tube, the ends of the heating tubes are often difficult to be heated. The so-called cold end causes an uneven heating of the food material in the cooking space, resulting in poor cooking effects. In addition, with this arrangement, the space right below or near the far-infrared heating tube is heated quickly but a space far from the heating tube receives less heat and the temperature rises slowly. In other words, existing top heating assembly cannot ensure an even heating, neither in a horizontal plane nor in a 3D space.

### SUMMARY OF THE INVENTION

To solve at least part of the above problems, the invention proposes a multicooker with a heating assembly which is more effective and ensures an even heating of the cooking space.

Specifically, the invention provides a cooking appliance having a lid and an inner pot forming a cooking space for receiving food material, the lid being arranged over the inner pot and movable between a closed position and an open position, wherein the lid comprises a heating assembly including a heating device, a reflective plate and a light-transmission plate located below the reflective plate, the reflective plate and the light-transmission plate defining a heating space in which the heating device is arranged, the heating device comprising a first heating tube and a second heating tube, each heating tube presenting a semi-enclosed shape with an opening, the first heating tube being surrounded by the second heating tube and the opening of the first heating tube being arranged to face a body portion of the second heating tube without opening, the reflective plate comprising a reflection enhancing zone disposed between the first heating tube and the second heating tube, the reflection enhancing zone being configured to enhance the reflection of radiation for both the first heating tube and the second heating tube.

The heating device according to the present invention comprises two heating tubes which can be more powerful compared to a single heating tube. The general shape of each heating tube is a semi-enclosed shape with an opening, such as a C-shape or a U-shape, or even a rectangular form with an opening in one of the borders. Electrical terminals are located in the opening. As described in the background section, the opening is the cold end of the heating tube. By disposing the first heating tube surrounded by the second heating tube with the its opening facing a body portion of the second heating tube, the reduction of radiation at the cold end of the first heating tube is compensated by the second heating tube. Preferably, the opening of the first heating tube is arranged to face the body portion of the second heating tube opposite its opening. In other words, the openings of the first and second heating tubes are opposite each other, so that each cold end is compensated by the other heating tube. The overall radiation of the heating device is therefore uniformed, so as to improve the evenness of temperature in the cooking space.

Further, the “light-transmission plate” should be understood as a plate allowing at least part of the radiation generated by the heating tubes to pass through. In function of the wavelengths of the radiation generated by the heating tubes, the light-transmission plate may be transparent to visible lights or not. The light-transmission plate is arranged to partially delimit the cooking space. In other words, the radiation generated by the heating tubes passes through the light-transmission plate to directly enter the cooking space.

The reflective plate and the light-transmission plate define together a heating space in which the heating device is arranged. The heating assembly is fastened in the lid of the multicooker. When the lid is opened, the light-transmission plate is visible from the bottom of the lid. It is understood that the light-transmission plate defines the lower wall of the heating space. The reflective plate preferably comprises a top wall and a lateral wall which respectively constitutes the top wall and lateral wall of the heating space. The inner surface of the reflective plate is capable of reflecting and/or scattering the radiation generated by the heating tubes. In fact, the heating tube emits radiation towards every direction around it. The function of the reflective plate is to redirect the radiation emitted upward or sideward towards downward so as to enter the cooking space. Thanks to the reflective plate, the heat efficiency of the heating tubes is improved. In addition, the scattering effect allows a better evenness of radiation.

Further, the reflective plate comprises a reflection enhancing zone disposed between the first heating tube and the second heating tube, the reflection enhancing zone being configured to enhance the reflection of radiation for both the first heating tube and the second heating tube. Especially, the location and the shape of the reflection enhancing zone are carefully chosen by the inventors through experiments and simulations. Compared to a flat surface that may have been provided as the inner surface of the reflective plate, the reflection enhancing zone according to the present invention can further enhance the reflection and/or scattering of the radiation generated by both heating tubes, so as to improve the heat efficiency and evenness of radiation.

Therefore, the cooking appliance according to the invention allows to overcome the drawbacks of existing heating assembly in the lid and to improve the evenness of heating in the cooking space.

The cooking appliance according to the invention may further comprise the following features, taken alone or combined:
the first and second heating tubes are far-infrared heating tubes. The far-infrared heating tube has the advantages of high intensity, high thermal efficiency, high penetration capacity and low energy consumption.
the first and second heating tube each presents a C-shape. The heating tube may also present other semi-enclosed shapes such as U-shape, or an oval or rectangular shape with an opening, etc. depending on the shape of lid and aesthetic design thereof.
the first and second heating tubes are fixed to the reflective plate, for example via clips or brackets. It is advantageous to leave a vertical distance between the reflective plate and the heating tubes, so as to ensure a better reflection effect and to avoid the need of heat insulation therebetween.
the light-transmission plate is sealed with a lower end of the reflective plate by means of a peripheral seal. Since the multicooker may have the function of cooking food material with water, vapor could be generated inside the cooking space. It is thus advantageous to seal the heating assembly which is electrically powered.
the light-transmission plate is made of glass, for example glass-ceramic or tempered glass. The glass allows at least part, preferred a great part, of the radiation emitted by the heating tubes to pass through. However, it could be opaque or translucent to visible lights, so that the user may not see the heating tubes arranged inside the heating space, leaving more liberty to the designer of the multicooker. The light-transmission plate can also be made of transparent plastic.
the light-transmission plate comprises an upper surface facing the heating space and a lower surface facing the cooking space, the light-transmission plate comprising a reflective layer disposed on the upper surface and/or the lower surface. In this preferred embodiment, the radiation emitted by the heating tubes is reflected between the reflective plate and the reflective layer of the light-transmission plate, so as to reduce the fraction of radiation that directly passes through the light-transmission plate which will raise the temperature of some particular portions. In this way, the temperature difference of virous portions of the light-transmission plate is reduced and the light-transmission plate is more evenly heated. Consequently, the food material in the cooking space is also more evenly heated.
the reflection enhancing zone comprises two protrusions extending downwards from an upper wall of the reflective plate and both disposed between the first heating tube and the second heating tube. The protrusions provide a greater area of reflection surface, which further improves the reflection and scattering of the radiation emitted by the heating tubes. The surfaces of the two protrusions are located between the first and second heating tubes so that they can serve for both heating tubes.
when the first and second heating tube each presents a C-shape, each protrusion presents an arc shape and are disposed opposite each other. The curve of the protrusions follows the curve shape of the heating tubes, which allows to provide as much additional reflection/scattering surface as possible.
the reflection enhancing zone comprises a convex surface disposed between the first heating tube and the second heating tube, the convex surface further comprising a plurality of embossments. The embossments form a rough surface which provides better scattering effect to radiation emitted by the heating tubes.
the embossments are evenly distributed on the convex surface. This arrangement allows the scattered radiation to be evenly reflected to the light-transmission plate.
the lid comprises a steam channel connecting the cooking space and the outside of the cooking appliance, the reflective plate comprising a mounting hole configured to receive and position the steam channel, the mounting hole being disposed to pass through the opening of the first heating tube or of the second heating tube. Therefore, the steam channel is located at the opening, i.e. the cold end of one of the heating tubes where the temperature rise is the lowest. This arrangement allows to prevent the overheating of parts inside the heating space and results in an improved safety.

### DESCRIPTION OF THE DRAWINGS

FIG. 1 is a schematic sectional view of a multicooker according to one embodiment of the invention;

FIG. 2 is an enlarged sectional view of the heating assembly shown in FIG. 1;

FIG. 3 is a schematic bottom view of the heating assembly of FIG. 1, with the light-transmission plate omitted;

FIG. 4 is an exploded view in perspective of the heating assembly of FIG. 1;

FIG. 5 is a sectional view of a heating assembly according to another embodiment.

### DETAILED DESCRIPTION OF THE INVENTION

Exemplary embodiments, which are illustrated in the accompanying drawings, will be described in detail here. In the description below related to figures, unless otherwise indicated, the same numbers in different figures refer to the same or similar elements. The modes of realization described in the following exemplary embodiments do not represent all modes of realization in accordance with the invention. Instead, they are merely examples of devices in accordance with some aspects of the invention described in detail in the appended claims.

The terms used in the application are merely for the purpose of describing specific embodiments, and not intended to be limiting. Singular forms, “one” and “the,” used in the description and the appended claims of the application are also intended to include the plural form, unless the context clearly indicates otherwise. It should also be understood that the term “and/or” used herein means and includes any and all possible combinations of one or more of the associated listed items.

It should be understood that, although the application may use terms such as “first,” “second,” and “third” to describe various items of information, those items of information are not limited to those terms. Those terms are merely used to distinguish information of the same type. For example, without departing from the scope of the invention, a first item of information can also be referred to as a second item of information. Similarly, a second item of information can also be referred to as a third item of information. Depending on the context, such as terms used therein, “if” can be construed as “when . . . ” or “in the event that . . . ” or “in response to the determination that . . . .”

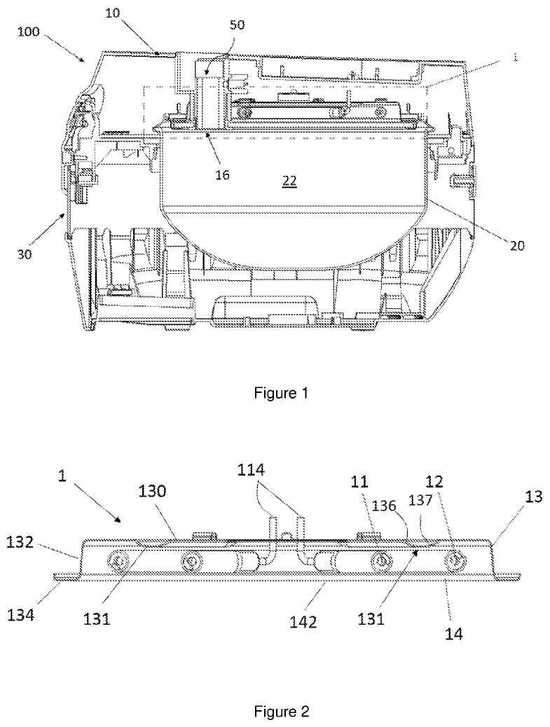

FIG. 1 shows a cooking appliance 100 according to one embodiment of the invention. The cooking appliance 100 is for example powered by electricity and can realize divers functions of cooking, such as rice cooking, soymilk making, and especially cake baking or grill. The cooking appliance 100 is thus also called a multicooker. As conventional structure, the cooking appliance 100 comprises a body 30 and a lid 10 which is hinged to the top end of the body 30. An inner pot 20 is movably arranged inside the body 30 and forms a cooking space 22 for receiving food material to be cooked. The lid 10 is movable between a closed position at which it closes the cooking space 22 and an open position at which it leaves the cooking space 22 accessible from exterior. In FIG. 1, the lid 10 is in its closed position. FIG. 1 also shows that the lid 10 comprises a heating assembly 1 and a steam channel 50 which will be described below.

The heating assembly 1 is more clearly illustrated in FIGS. 2 to 4. Specifically, the heating assembly 1 comprises two heating tubes 11, 12 constituting a heating device. The heating assembly 1 also comprises a reflective plate 13 and a light-transmission plate 14 located below the reflective plate 13. The reflective plate 13 and the light-transmission plate 14 defines a heating space in which the heating device, i.e. the first heating tube 11 and the second heating tube 12, are arranged. The first heating tube 11 and the second heating tube 12 are fixed to the reflective plate 13 via clips 138.

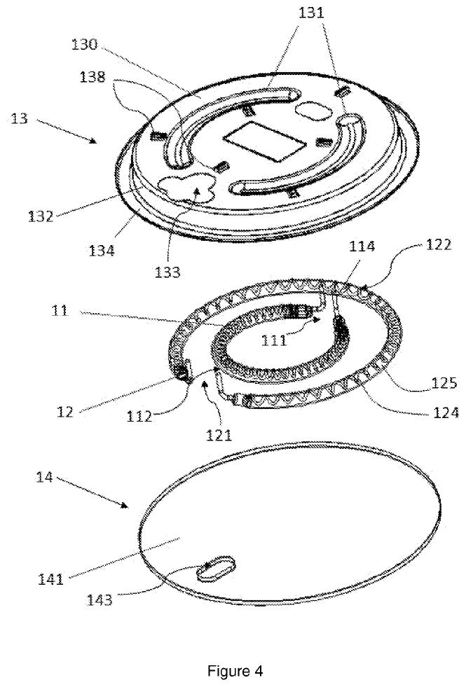

As shown in FIGS. 2 and 4, the reflective plate 13 comprises a top wall 130 and a lateral wall 132 extending downward from the top wall 130 and comprising a flange 134. The top wall 130 and the lateral wall 132 of the reflective plate 13 respectively constitutes the top wall and lateral wall of the heating space. In this embodiment, the light-transmission plate 14 is substantially a flat piece which is assembled with the flange 134 of the reflective plate 13 by means of a clamp and sealed by a peripheral sealing element (not shown). The light-transmission plate 14 constitutes the bottom wall of the heating space and is in direct contact with the cooking space 22.

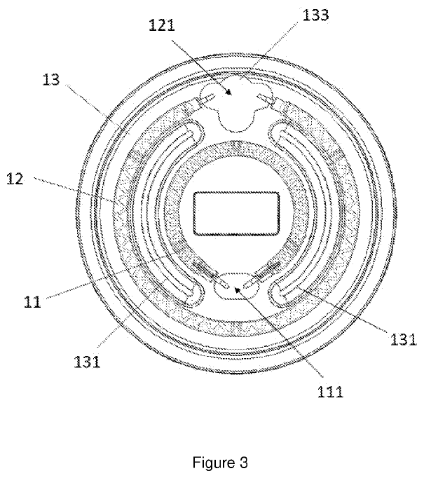

In this embodiment, the heating tubes 11, 12 are both far-infrared heating tubes, each comprising a metallic filament 124 enclosed by a tubular shell 125. The first heating tube 11 is powered by electricity via terminals 114 which extend upward from the plane of the first heating tube 11. It is known that the heating effect at the terminals 114 is not as good as in other parts of the filament. As shown in FIGS. 3 and 4, the first heating tube 11 presents an annular form with an opening 111, thus forming a semi-enclosed general shape. Both terminals 114 are located at the opening 111, which forms a so-called cold end. The first heating tube 11 is surrounded by the second heating tube 12 located in the same plane. The second heating tube 12 presents a same general shape as the first heating tube 11 but with a greater diameter.

According to the invention, the opening 111 or the cold end of the first heating tube 11 is arranged to face a body portion 122 of the second heating tube 12, which is thus not the opening 122 of the second heating tube 12. At the same time, the opening 121 of the second heating tube 12 is also arranged to face a body portion 112 of the first heating tube 11. In this way, the cold end of each heating tube is radially adjacent to a body portion of the other heating tube, which allows to compensate the reduced heating effect due to the presence of the cold end. Therefore, the overall heating effect is uniformed to a certain extent. In this embodiment, the opening 111 of the first heating tube 11 is arranged opposite the opening 121 of the second heating tube 12. In other words, the two openings 111, 121 are diametrically opposed. However, if need be, the openings can also be arranged with a non-zero angle.

As shown in FIGS. 2 to 4, the top wall 130 of reflective plate 13 comprises two protrusions 131 extending downwards into the heating space and both disposed between the first heating tube 11 and the second heating tube 12. From the top or bottom view, each protrusion 131 presents an arc shape which extends along the annular body of the first and second heating tubes. The two protrusions 131 constitute a reflection enhancing zone of the invention, which is configured to enhance the reflection of radiation for both the first heating tube 11 and the second heating tube 12. In fact, as best shown in FIG. 2, the vertical section of the protrusion 131 is defined by a curve with its lowest point located in a middle part of the curve. Since the protrusion 131 is disposed radially between the first heating tube 11 and the second heating tube 12, its curved surface has two portions 136, 137 respectively mainly facing the first and second heating tubes. The portion 136 extends from the general plane of the top wall 130 to the lowest point of the curve, thus oriented to face the first heating tube 11, so as to form a reflecting surface for the first heating tube 11. Similarly, the portion 137 extends from the lowest point of the curve to the general plane of the top wall 130, thus oriented to face the second heating tube 12, so as to form a reflecting surface for the second heating tube 12. Thus, the radiation emitted by heating tubes 11, 12 are better scattered by the protrusions 131. In addition, in actual use of the multicooker 100, it is possible that only one heating tube is powered in certain functions or scenarios. The protrusions 131 in this embodiment are capable of enhancing the reflection of the radiation emitted by each of the heating tubes, which is thus a highly-adaptive arrangement.

The reflective plate 13 is made of a reflective material, such as stainless steel, preferably processed by mirror finishing. Alternatively, the inner surface of the reflective plate 13 may be coated with a reflective layer, such as a silver paper or aluminum foil. The inner surface includes the inner surface of the top wall 130, of the lateral wall 132 and of the protrusions 131. These embodiments are advantageous because they can improve the reflection of the radiation emitted by the heating tubes, and thus improve the heat efficiency of the heating assembly.

The light-transmission plate 14 is made of glass, for example glass-ceramic or tempered glass. In a further preferred embodiment not shown in the figures, the upper surface 141 and/or the lower surface 142 of the light-transmission plate 14 is also provided with a reflective layer which is printed or electroplated on one or both surfaces. When the far-infrared light arrives at the light-transmission plate 14, it is blocked or weakened by the reflective layer. The far-infrared light is thus reflected between the reflective plate 13 and the reflective layer of the light-transmission plate 14 so that the entire light-transmission plate 14 is uniformly heated. Therefore, the temperature difference of various parts of the light-transmission plate 14 is reduced, so that the cooling space is evenly heated through the surface of the light-transmission plate 14. The cooking effect is thus improved.

It can also be seen from FIGS. 1 to 4 that the heating assembly 1 comprises a mounting hole 16, through which a steam channel 50 passes. More specifically, the reflective plate 13 comprises an upper hole 133 and the light-transmission plate 14 comprises a lower hole 143 at a corresponding location. In this embodiment, the mounting hole 16 passes though the opening 121 of the second heating tube 12. Therefore, the steam channel 50 is located at the opening, i.e. the cold end of the second heating tube where the temperature rise is the lowest. This arrangement allows to prevent the overheating of parts inside the heating space and results in an improved safety.

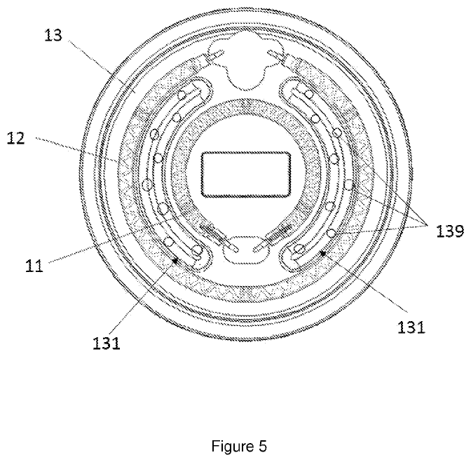

In the embodiment illustrated in FIG. 5, which is very similar to the embodiment described above, except that the convex surface of the protrusions 131 is further provided with a plurality of embossments 139. The embossments 139 are evenly arranged and form a rough surface for the convex surface which thus provides better scattering effect to the radiation emitted by the heating tubes. However, it is noted that the reflection enhancing zone does not necessarily comprise the two arc-shaped protrusions 131 as shown in FIGS. 5 and 3 but may also be other forms in a top view. The convex surface of the reflection enhancing zone may also differ from the form shown in FIG. 2 as long as it is capable of enhancing the reflection of radiation emitted by both the first and second heating tubes. In particular, the convex surface may comprise two portions respectively facing the first and second heating tubes.

What have been described above are merely preferred embodiments of the invention, and not for the purpose of limiting the invention. When there is no conflict, the above-described embodiments can be combined with each other. Any modification, equivalent replacement or improvement made within the spirit and principles of the invention falls within the scope of protection of the invention.

For example, the heating assembly may comprise more than two heating tubes, which may be other than far-infrared type. The reflection enhancing zone may present other shapes, such as plurality of embossments directly formed on the inner surface of the reflective plate. The light-transmission plate may be made of transparent plastic.

1. A cooking appliance having a lid and an inner pot forming a cooking space for receiving food material, the lid being arranged over the inner pot and movable between a closed position and an open position, wherein the lid comprises a heating assembly including a heating device, a reflective plate and a light-transmission plate located below the reflective plate, the reflective plate and the light-transmission plate defining a heating space in which the heating device is arranged, the heating device comprising a first heating tube and a second heating tube, each heating tube presenting a semi-enclosed shape with an opening, the first heating tube being surrounded by the second heating tube and the opening of the first heating tube being arranged to face a body portion of the second heating tube without opening, the reflective plate comprising a reflection enhancing zone disposed between the first heating tube and the second heating tube, the reflection enhancing zone being configured to enhance the reflection of radiation for both the first heating tube and the second heating tube.

2. The cooking appliance according to claim 1, wherein the first and second heating tubes are far-infrared heating tubes.

3. The cooking appliance according to claim 1, wherein the first and second heating tube each presents a C-shape.

4. The cooking appliance according to claim 1, wherein the first and second heating tubes are fixed to the reflective plate, for example via clips.

5. The cooking appliance according to claim 1, wherein the light-transmission plate is sealed with a lower end of the reflective plate by means of a peripheral seal.

6. The cooking appliance according to claim 1, wherein the light-transmission plate is made of glass.

7. The cooking appliance according to claim 1, wherein the light-transmission plate comprises an upper surface facing the heating space and a lower surface facing the cooking space, the light-transmission plate comprising a reflective layer disposed on the upper surface and/or the lower surface.

8. The cooking appliance according to claim 1, wherein the reflection enhancing zone comprises two protrusions extending downwards into the heating space and both disposed between the first heating tube and the second heating tube.

9. The cooking appliance according to claim 8, wherein the first and second heating tube each presents a C-shape, each protrusion presents an arc shape and is disposed opposite each other.

10. The cooking appliance according to claim 1, wherein the reflection enhancing zone comprises a convex surface disposed between the first heating tube and the second heating tube, the convex surface further comprising a plurality of embossments.

11. The cooking appliance according to claim 10, wherein the embossments are evenly distributed on the convex surface.

12. The cooking appliance according to claim 1, wherein the lid comprises a steam channel connecting the cooking space and the outside of the cooking appliance, the reflective plate comprising a mounting hole destinated to receive and position the steam channel, the mounting hole being disposed to pass through the opening of the first heating tube or the second heating tube.
